(19) United States
(12) Patent Application Publication
(10) Pub. No.: US 2023/0401374 A1
(43) Pub. Date: Dec. 14, 2023

(54) READING METHOD AND APPARATUS

(71) Applicant: BRIGHTPAGE TECHNOLOGIES LTD, Glasgow (GB)

(72) Inventor: Howard Farnoush Freemantle MOSHTAEL-OSKUI, Edinburgh (GB)

(73) Assignee: BRIGHTPAGE TECHNOLOGIES LTD, Glasgow (GB)

(21) Appl. No.: 18/333,733

(22) Filed: Jun. 13, 2023

(30) Foreign Application Priority Data
Jun. 14, 2022 (GB) 2208734.0

(51) Int. Cl. G06F 40/106; G06F 40/169; G06F 40/30

(52) U.S. Cl. CPC G06F 40/106; G06F 40/169; G06F 40/30

(57) ABSTRACT

A method (100) of displaying a document to a user on a display screen, the document comprising text, wherein the method comprises: displaying (110) an overview of a portion of the document on the display screen; subsequently, sequentially displaying (120), in a predetermined position of the display screen, consecutive units of a selected text portion of the overview of the portion of the document; and simultaneously to displaying a displayed unit of the consecutive units of the selected text portion, displaying (130) context comprising textual context of the displayed unit of the consecutive units.

### RELATED APPLICATIONS

This application claims the priority of UK application GB 2208734.0 filed on 14 Jun. 2022, which is herein incorporated by reference in its entirety for all purposes.

### FIELD OF THE INVENTION

The present invention relates to a reading method and apparatus for displaying a document to a user on a display screen

### BACKGROUND OF THE INVENTION

Display screens are often used to display an electronic document to a user. Typically, the document is displayed on the display screen and a user must read across and down the display screen. The user is required to continuously move their eyes and change the focus of their eyesight. This is inconvenient and can lead to mistakes in reading which slow down the user, such as reading the same line twice. In addition, the user is required to navigate around the document on the display screen to read the document. This can be a time consuming and confusing process.

Furthermore, with conventional display techniques for documents, the user is required to remember where he/she stops reading in order to return to reading the document from the same place at a later point in time. Often, a user in this situation will find themselves re-reading the same part of the document, wasting time, or will find that they have left a part of the document unread.

WO 2018/046957 A2 relates to a reading system where a line of text is scrolled intermittently from left to right through a reading position on which the reader is intended to fixate while reading the text.

It is in this context that the present invention has been devised.

### SUMMARY OF THE INVENTION

An aspect of the invention provides a method of displaying a document to a user on a display screen. The document typically comprises text. The method comprises displaying an overview of a portion of the document on the display screen. The method comprises subsequently, sequentially displaying, in a predetermined position of the display screen, consecutive units of a selected text portion of the overview of the portion of the document. The method comprises, simultaneously to displaying a displayed unit of the consecutive units of the selected text portion, displaying context comprising textual context of the displayed unit of the consecutive units.

An aspect of the invention provides a controller for a display device to cause the display device to display a document to a user. The controller comprises one or more processors. The controller comprises a non-transitory computer readable memory storing instructions which, when executed by the one or more processors, causes the controller to: display an overview of a portion of the document on a display screen of the display device. Typically, the document comprises text. The instructions, when executed by the one or more processors, further cause the controller to subsequently, sequentially display, in a predetermined position of the display screen, consecutive units of a selected text portion of the overview of the portion of the document. The instructions, when executed by the one or more processors, further causes the controller to, simultaneously to display of a displayed unit of the consecutive units of the selected text portion, display context comprising textual context of the displayed unit of the consecutive units.

Advantageously, displaying an overview prior to the sequential display of the consecutive units allows the user to view the document with more information available to the user than the information provided by the sequential display of the consecutive units (i.e. scrolling) alone. Nevertheless, even though the overview of the document is helpful for obtaining a broad understanding of the general format and perhaps some indication of topics covered by the document, it has been realised that combining this with reading a selected text portion using sequential display of the consecutive units is particularly useful for increasing the user's reading speed of the detailed text of the document. In other words, reading the selected text portion in isolation may not provide the user with all the information available to the user to help him/her to understand the document quickly. By providing the overview, the user is able to develop a better understanding of the document as a whole and potentially to decide whether to read the document at all. For example, the overview provides more information regarding: the length of the document, the type of document based on the layout (i.e. an academic journal typically has two columns of text per page and a novel usually has one column per page), the intended audience of the document (i.e. documents aimed at children often have larger text with more images than a document aimed at adults) and a theme of the document (i.e. images of celebrities may indicate that the document is a magazine article and images of x-rays may indicate that the document is a medical paper). In other words, the overview of the document provides the user with more information than would otherwise be available using the sequential display alone. This allows the user to make an informed decision about whether to proceed to read the document and to improve their understanding of the selected text portion by using information about the document taken from the overview. By combining display of an overview of the document with the subsequent sequential display, in a predetermined position of the display screen, consecutive units of a selected text portion of the overview of the portion of the document, the user is provided with an optimum user experience, enabling particularly efficient comprehension of the information contained in the document.

The scrolling display provides a reading method to improve a user's reading speed and focus when reading and is displayed in combination with display of the overview which provides the benefits of a conventional view of a document on the display screen (i.e. displaying the entire document on the display screen). The overview provides the user with additional information to aid the user's understanding of the document, when compared to the scrolling display alone, and improves of navigation around the document. In this way, the overview page functions as a document map whilst scanning over the document as a whole and the scrolling display provides a reading method when reading a selected text portion.

Typically, the display screen is an electronic device for displaying a document to the user. The display screen may be a touchscreen display. It may be that the display screen is integrated in the display device. The display device may be a mobile phone, a smart watch, a PC monitor, a laptop or a television. It will be appreciated that other display devices are envisaged.

The controller may be configured to perform any steps of the methods described herein. The controller for the display device comprises the one or more processors. The controller comprises the non-transitory computer readable memory storing instructions. The instructions, when executed by the one or more processors may cause the controller to operate the display screen as described herein. The one or more processors may be located in a single unit. In other examples, where the one or more processors is a plurality of processors, the controller may be distributed, which is to say that at least one of the plurality of processors may be located separated from at least one other of the plurality of processors. Typically, the display device comprises the controller, but in other examples, the controller may be provided separate from the display device and in wireless data communication therewith.

Typically, the document is an electronic document. The document may be displayed on the display screen using computer software. The document may be a webpage displayed on the display screen using a web browser. The document may be a webpage displayed using an extension (i.e. an add-on) for the web browser. The document may be displayed on the display screen using a computer application. The computer application may comprise a document display window to display the document to the user. The application may comprise a text display window to display text that has been pasted into the text display window from another program. The document may be an article sourced through a data feed. The document may be an article sourced through an application programming interface (API). The document may be an ebook. The document may have a .pdf, .txt, .doc, .docx, .rtf, pages, .odf, .epub, .htm or html file format. It will be appreciated that other file formats for the document are envisaged.

The document may comprise one or more additional components including at least one of: one or more images, one or more videos and one or more audio files. The additional components may be embedded in the document.

Typically, the portion of the document displayed in the overview on the display screen may comprise the document in its entirety. The portion of the document displayed in the overview on the display screen may be a partial view of the document. For example, the overview may comprise a quadrant of the document. The overview of the document may be displayed in dependence on an aspect ratio of the document or the display screen. The document may be displayed in dependence on a display resolution of the display screen. The overview of the document may be displayed at a first zoom corresponding to a page width, one-page, multiple pages or a percentage, where 100% zoom is a view of the document on the display screen corresponding to a size of a printed version of the document or a view of the document on the display screen corresponding to a relative size of the display screen.

Typically, the user may be able to navigate around the overview of the document, using a navigation input, to display a different portion of the document in the overview compared to the default portion displayed on the display screen. For example, the user may be able to touch the display screen to navigate around the document to change the portion of the document displayed in the overview. The user may be able to use a control device, such as a computer mouse or remote, to navigate around the document to change the portion of the document displayed in the overview.

For the various user inputs described herein, it will be appreciated that the input may be a touch input on the display screen. Alternatively, the input may be provided using a control device, such as a computer mouse or remote.

Typically, a unit comprises a word or number from the text of the document. For example, a unit may comprise a portion of the text between two word-separating punctuation devices, such as a space, a full stop, an exclamation mark, a question mark or a comma. Where the punctuation device is other than a space, and is immediately adjacent to the portion of the text forming the unit, it can be included in the unit of text. It may be that every word in the selected text portion corresponds to a unit. It may be that at least one word in the selected text portion does not correspond to a unit. For example, the controller may determine whether to associate a word with a unit, e.g. words of three letters or less may not be associated with a unit and therefore these words may not be displayed in the predetermined portion and/or in the context. Typically, a unit comprises a group of words from the text of the document. Typically, consecutive units comprise a group of units that may be adjacent words from the selected text portion. That is, consecutive units may be words that follow on from one another directly in the selected text portion.

Typically, the predetermined position corresponds to a specified position on the display screen. The predetermined position may be an area or region of the display screen. The predetermined position may be specified according to the computer code of the computer software. The predetermined position may depend on a size of the display screen. For example, the predetermined position may correspond to a centre portion of the display screen, that is a position on the display screen at 50% of the height of the display screen and 50% of the width of the display screen.

Advantageously, displaying each of the consecutive units in the predetermined position reduces the need for the user to move their eyes across substantially the entire width of the display screen as is required to read documents displayed conventionally. As a result, the user is able to read documents displayed on a display screen in accordance with the invention for a longer period of time before experiencing eye-tiredness when compared with conventional displays.

Typically, the predetermined position of the display screen is associated with a visual indication. The visual indication may outline, or draw the user's attention to, the unit displayed in predetermined position The visual indication may be a format difference of the unit displayed in the predetermined position compared to other items displayed on the display screen (e.g. the context). For example, the unit displayed in the predetermined unit may be displayed using different colour, font size, or font weight to the context. The visual indication may be an item displayed on the display screen, for example, a box outlining the visual indication or pair of arrows pointing to the visual indication. The visual indication of the predetermined position may be different to a visual indication associated with the context.

Optionally, the displayed unit is displayed within the visual indication. For example, when the visual indication is a box displayed on the display screen, the displayed unit may be displayed within the box. In other examples, when the visual indication is a pair of arrows facing one another, the displayed unit may be displayed between the arrows.

Advantageously, associating the predetermined position with the visual indication focusses the user's attention and eyesight to the predetermined position. As a result, the user is able to read for longer before experiencing eye-tiredness and eye strain when reading a document displayed in accordance with the invention.

Typically, sequentially displaying the consecutive units comprises displaying units (i.e. words) that follow on from one another directly in the selected text portion in sequence in the predetermined position. Sequential display of the consecutive units may comprise displaying one of the consecutive units in the predetermined position at a time. In some examples, the sequential display of the consecutive units may be referred to as “scrolling”. It may be that a plurality of the consecutive units are displayed on the display screen at one time. For example, a unit of the consecutive units may be displayed in the predetermined position with a previous unit to the displayed unit displayed to the left of the predetermined position and a unit following the displayed unit displayed to the right of the predetermined position. The sequential display may be a sequence having an order from left to right of the display screen or right to left of the display screen. The sequential display may be a sequence having an order from top to bottom of the display screen or bottom to top of the display screen. The order of the sequential display of the consecutive units may be determined in dependence on a language of the document. For example, an order of the sequential display may be from left to right of the selected text portion for left-to-right script (e.g. English, French or German) or may be from right to left of the selected text portion for right-to-left script (e.g. Arabic or Hebrew).

Typically, the sequential display progresses through the sequence of displaying the consecutive units with a progression speed. The progression speed may be measured using words per minute. In this way, the words per minute may correspond to a number of units shown in the predetermined position per minute. Each unit may be displayed in the predetermined position for a predetermined period. The predetermined period may be the same for each unit. The predetermined period may be determined individually for each unit, such that the number of words displayed in the consecutive units within a specified period of time (e.g. one minute) corresponds to the progression speed (e.g. measured in words per minute). The controller may calculate the predetermined period for each unit in dependence on the progression speed.

The progression speed may be selected by the user or determined by the controller. The method may comprise receiving a speed setting input from the user, in which the user selects the desired progression speed for the sequential display. The controller may be configured to determine the progression speed for the user. For example, the controller may store the progression speed of the user from a previous reading session.

The sequential display of the consecutive units is subsequent to (i.e. follows, or is after) display of the overview of the portion of the document. For example, the sequential display of the consecutive units may be subsequent to a first indication indicative of a trigger to initiate the sequential display of the consecutive units. An initial unit of the sequentially displayed consecutive units may be an initial unit of the document. Alternatively, the initial unit of the sequentially displayed consecutive units may be an initial unit of the selected text portion.

It may be that the selected text portion comprises a portion of text from the document. The selected text portion may be selected by the user or by the computer code of the application. For example, the application may select a predetermined portion of the document as the selected text portion. The selected text portion may correspond to the first text in the document (i.e. a title at the top of the document or a first paragraph of the document). In some examples, the selected text portion is selected by the user input, for example, the first indication. The user may select a portion of text from the overview of the portion of the document that he/she wishes to read using the sequential display of the consecutive units.

It may be that the first indication is a selection input from the user. Typically, the method may comprise receiving a selection input from the user. The method may further comprise initiating the sequential display, in the predetermined position of the display screen, of the consecutive units, subsequent to the selection input. Typically, the instructions, when executed by the one or more processors, cause the controller to: receive a selection input from the user. The instructions, when executed by the one or more processors, may cause the controller to initiate the sequential display, in the predetermined position of the display screen, of the consecutive units, subsequent to the selection input.

Advantageously, the selection input allows the user to navigate quickly through the document to select the desired portion of text to be read. The display of the overview allows the user to quickly select a portion of text of the document to be sequentially displayed for reading. In conventional displays, the user is required to scroll through the document, for example using either a scroll bar, scroll wheel or a sliding touch input, to find the part of the document to be read. This is particularly inconvenient on small display screens such as those provided with mobile phones. In the present invention, the user is able to directly select text to be read via sequential display in the predetermined position from the display of the overview of the document.

In addition, it is difficult to read text and view images displayed on small display screens. The user is required to zoom in on the text he/she wishes to read which results in part of the document not being displayed on the screen. The user is then required to move across the zoomed in text to read across each line. Advantageously, the selection input allows a user to easily select text to be displayed using the scrolling method of the present invention. The selected text portion will then be scrolled through automatically without the user being required to move the text across the screen or move their eyes across the screen.

The selection input may be one or more user inputs to select the selected text portion and initiate sequential display of the consecutive units. It may be that a first selection input is received to select the selected text portion and initiation of the sequential display of the consecutive units occurs substantially immediately (i.e. within 5 seconds, 3 seconds or 1 second) after the first selection input. The initial unit displayed in the sequential display of the consecutive units may correspond to an initial unit of the selected text portion. In this way, one selection input may be received to both select the selected text portion and initiate the sequential display of the consecutive units. It may be that a first selection input is received to select the selected text portion. It may be that a second selection input is received to initiate the sequential display of the consecutive units. For example, the second selection input may correspond to pressing a ‘play’ button. In this way, two selection inputs may be received: a first selection input to select the selected text portion and a second selection input to initiate the sequential display of the consecutive units.

Simultaneous display of the context to display of the displayed unit may comprise displaying the displayed unit in the predetermined position at the same time as displaying context on the display screen.

Advantageously, display of context at the same time as display of a unit in the predetermined position provides the user with more information to develop a better understanding of the document being read. This allows the user to interpret the text whilst making use of parafoveal processing, in which words (i.e. units) displayed in the context surrounding the word (i.e. unit) displayed in the predetermined position aid in comprehension of the unit displayed in the predetermined position (and the document overall). In particular, displaying a unit in isolation may be confusing for the reader as the meaning of a word may be influenced by the other words it is used in combination with (i.e. the other words in a sentence). Viewed another way, it can also be understood that display of the context at the same time as display of the unit in the predetermined position can also increase the speed at which a user can read the document.

In addition, displaying context in combination with the unit in the predetermined position can include displaying at least a part of a sentence. This allows the user to view text in sentence view (i.e. conventional static display of a sentence), which is familiar to the user, without the need to make saccades across the text. Therefore, displaying the text using scrolling in combination with the context is a more user-friendly and convenient type of reading method for the user compared to sequential display of a single word in isolation from the rest of the text (e.g. as with rapid serial visual presentation, RSVP).

The context comprises textual context. The textual context may comprise text from the document. Typically, the context comprises at least part of the selected text portion of the document. Typically, the context comprises, at least one of: text intended for reading subsequent to the displayed unit, or text intended for reading prior to the displayed unit. Typically, the context comprises part of a clause or sentence of the selected text portion including the unit. In this way, the context may comprise one or more units of the selected text portion consecutive to the displayed unit in the predetermined position. The context may comprise a unit, of the selected text portion of the document, that was previously displayed in the predetermined position. The context may comprise a unit, of the selected text portion of the document, that is to be displayed in the predetermined position. Optionally, the context comprises part of a sentence of the selected text portion which does not include the unit.

Typically, the context is displayed on the display screen in a first position of the display screen adjacent to the predetermined position. The first position may be positioned to the left or right of the predetermined position of the display screen. The first position may be positioned above or below the predetermined position. It may be that the context is displayed on the display screen in a second position of the display screen adjacent to the predetermined position. The second position may be positioned to the left or right of the predetermined position of the display screen and/or the second position may be positioned above or below the predetermined position. The context may be displayed in the first position and the second position. The predetermined position may be positioned vertically or horizontally in between the first position and the second position.

Advantageously, displaying the context in a position adjacent to the predetermined position reduces the need for the user to move their eyes across substantially the entire display screen when reading. This allows the user to read for a longer period of time before experiencing eye-tiredness or losing focus when compared to conventional display techniques for documents, as well as increasing a speed with which a user can read the text. In addition, the context improves the user's understanding of the unit (i.e. word) displayed in the predetermined position.

Typically, the context comprises pictorial context of the displayed unit. The pictorial context may be an image included in the document. The pictorial context may be associated with the unit displayed in the predetermined position (i.e. an image caption or an image corresponding to the meaning of the unit).

Typically, the display screen may provide a display corresponding to a first mode in which text (i.e. paragraphs) preceding and following the selected text portion is not displayed on the display screen during sequential display of the consecutive units. This type of display may be a scrolling display. This type of display may improve the user's focus on the predetermined position.

Typically, the display screen may provide a display corresponding to a second mode in which text (i.e. paragraphs) preceding and following the selected text portion is displayed on the display screen when the sequential display of the consecutive units is paused or has not yet started. This type of display may be a paused display or an initial display. This type of display provides the user with additional information to understand the document.

In the following aspects of the invention, the method does not require (or the controller is not caused to), simultaneously to displaying a displayed unit of the consecutive units of the selected text portion, displaying (or display) context comprising textual context of the displayed unit of the consecutive units. However, it may be an optional feature of the below described aspects of the invention.

It may be that the method comprises displaying each unit of the consecutive units of the selected text portion for a display period determined, for each unit, in dependence on one or more parameters, separate from a length of the displayed unit. It may be that the instructions, when executed by the one or more processors, cause the controller to display each unit of the consecutive units of the selected text portion for a display period determined, for each unit, in dependence on one or more parameters, separate from a length of the displayed unit. Typically, the one or more parameters comprising, at least one of: a document formatting parameter associated with at least one of: punctuation of the document, one or more paragraphs of the document, one or more headings of the document, text formatting of the document, a layout of the document and metadata of the document; and a unit comprehension parameter associated with at least one of: natural language processing techniques, a meaning of the unit to be displayed, a readability score of the document, one or more symbols of the unit to be displayed, one or more variables of the unit to be displayed compared to the other units of the document and statistics of the selected text.

This in itself is believed to be novel and so, in accordance with a further aspect of the invention there is provided a method of displaying a document to a user on a display screen comprising sequentially displaying, in a predetermined position of the display screen, consecutive units of a selected text portion of the document. Typically, the document may comprise text. The method further comprises displaying each unit of the consecutive units of the selected text portion for a display period determined, for each unit, in dependence on one or more parameters, separate from a length of the displayed unit. The one or more parameters may comprise, at least one of: a document formatting parameter associated with at least one of: punctuation of the document, one or more paragraphs of the document, one or more headings of the document, text formatting of the document, a layout of the document and metadata of the document, and a unit comprehension parameter associated with at least one of: natural language processing techniques, a meaning of the unit to be displayed, keyword analysis, a readability score of the document, one or more symbols of the unit to be displayed, one or more variables of the unit to be displayed compared to the other units of the document and statistics of the selected text portion.

The present invention further provides a controller for a display device to cause the display device to display a document to a user, the controller comprising: one or more processors; and a non-transitory computer readable memory storing instructions which, when executed by the one or more processors, causes the controller to sequentially display, in a predetermined position of a display screen of the display device, consecutive units of a selected text portion of the document. The instructions, when executed by the one or more processors, further cause the controller to display each unit of the consecutive units of the selected text portion for a display period determined, for each unit, in dependence on one or more parameters, separate from a length of the displayed unit. The one or more parameters may comprise, at least one of: a document formatting parameter associated with at least one of: punctuation of the document, one or more paragraphs of the document, one or more headings of the document, text formatting of the document, a layout of the document and metadata of the document, and a unit comprehension parameter associated with at least one of: natural language processing techniques, a meaning of the unit to be displayed, keyword analysis, a readability score of the document, one or more symbols of the unit to be displayed, one or more variables of the unit to be displayed compared to the other units of the document and statistics of the selected text portion.

Advantageously, displaying each unit for a display period in dependence on one or more parameters allows the sequential display of consecutive units to be displayed in a manner which increases reading efficiency of the user. For example, it has been realised that it is important to provide the user with time to insert pauses when intended by considering punctuation such as commas and full stops. At the same time, it has further been realised that the user is likely to need longer to read and understand a rare word (e.g. medical terminology such as “bradykinesia”) than a commonly-used word (e.g. “approximately”).

Typically, a display period refers to a period of time for which a unit is displayed in the predetermined position. Each unit of the consecutive units of the selected text portion may have a different display period. The total time a unit is displayed on the display screen for may be a total display time of the unit. It may be that the total display time of each unit comprises the display period in which the unit is displayed in the predetermined position and a time during which the unit is displayed on the display screen in the context, simultaneous to display of another unit in the predetermined position. The display period for each unit may vary in dependence on the content of the unit (i.e. the word being displayed in the predetermined position).

It may be that that the display period is determined, for each unit, in dependence on a user speed parameter. The user speed parameter may be selected by the user or determined by the controller in dependence on the user. The user speed parameter may relate to a user's reading speed. For example, the user speed parameter may be determined in dependence on the progression speed (i.e. reading speed measured in words per minute) or a reading type input from the user (e.g. the user may be required to select a reading type, such as “in-depth reading”, “skimming” or “average”).

It may be that the display period is determined during a processing stage of the document to be viewed on the display screen. The display period may be determined in dependence on one or more of (e.g. a combination of) the document formatting parameter, the unit comprehension parameter and the user speed parameter. That is, in a first processing step, a relative display period may be determined, for each unit, in dependence on at least one of: the document formatting parameter and the unit comprehension parameter. The relative display period may be indicative of a relative weighting of a display period for each unit relative to another unit. In other words, the display period for each unit can be determined using the relative display period and a parameter indicative of a speed parameter, such as an average number of words per minute. For example, the relative display period may represent a weighting to be applied to each unit in combination with the user speed parameter to obtain a calculated display period for any given unit. In a second processing step, the display period for each unit (i.e. the period of time for which a unit is displayed in the predetermined position) may be determined by applying the weighting to the user speed parameter.

It may be that the display period for each unit may be determined based on (i.e. in dependence on) the one or more parameters. The one or more parameters may be determined by the controller. The method may comprise determining the one or more parameters. Typically, the one or more parameters are associated with a variable corresponding to a feature of the document and/or a quantitative measure of the text of the document.

The one or more parameters may be separate from a length of the displayed unit (i.e. the unit to be displayed in the predetermined position). The length of the unit may correspond to a number of characters of the unit (i.e. number of letters or characters in a word or number of digits in a number). The one or more parameters may be associated with a variable that is not the length of the unit. The display period may be determined in dependence on the one or more parameters in addition to the length of the unit. It will be appreciated that the display period may be determined, at least in part, in dependence on another factor associated with the document other than the variables and parameters disclosed herein.

It may be that the document formatting parameter is associated with variables relating to formatting of a unit or the document in general. The document formatting parameter may be associated with punctuation of the document. For example, punctuation between consecutive units may indicate that: the user should take a pause when reading, resulting in a longer display period for a unit preceding a comma; a list is beginning in the selected text portion (e.g. a colon); a quote will begin in the subsequent unit following a quotation mark; or the unit comprises a hyphenated word (e.g. a hyphen). The document formatting parameter may be associated with one or more paragraphs of the document. For example, a paragraph break may indicate that the user should take a pause when reading, resulting in a longer display period for a unit preceding a paragraph break or a paragraph separated into bullet points or numbering may indicate that the selected text portion is a list, potentially resulting in a quick succession of sequential display of consecutive units. The document formatting parameter may be associated with one or more headings of the document (e.g. headings and titles included in the document). The document formatting parameter may be associated with text formatting of the document. The text formatting of the document may comprise font weight (bold and emphasis), typographical emphasis (italics and underlining) and font size. For example, a unit formatted with bold and underlined text formatting may be displayed for a longer display period than a unit with no bold or underlined text formatting. The text formatting of the document may comprise formatting of text dictated by computer code. For example, the text formatting of the document may comprise string escape sequences (e.g. \n, \r, \t).

The document formatting parameter may be associated with a layout of the document. For example, the layout of the document may include: a contents list, one or more headers and footers, one or more image captions, one or more columns, one or more asides, one or more boxouts, one or more sidebars and placement of intentional whitespace. The layout of the document may provide indication of the importance of a unit or the relevance of the unit which in turn is used to determine the display period. The document formatting parameter may be associated with metadata of the document (e.g. alternative text—“alt text”).

It may be that the unit comprehension parameter is associated with variables relating to the units being displayed in the predetermined position. The unit comprehension parameter may be associated with natural language processing techniques. For example, the natural language processing techniques may comprise syntactic analysis which may include parsing text and using basic grammar rules to identify sentence structure, how words are organised and how words relate to each other. Syntactic analysis may include tokenization (i.e. breaking text down into smaller parts e.g. sentences or words), keyword extraction (i.e. extracting relevant information from the text), speech tagging (i.e. labelling units as a noun, verb, adverb, adjective etc.), lemmatization and stemming (i.e. breaking down, tagging and restructuring data), reducing words to base form (e.g. interesting and interested have a base form of ‘interest’), stop word removal (i.e. removal of frequently occurring words that do not add semantic value e.g. “I”, “they”, “have”, etc). The natural language processing techniques may comprise semantic analysis to determine the meaning of text by studying the meaning of each individual word (unit) and studying the combination of words (units) and their meaning in context. Semantic analysis may further comprise word sense disambiguation (i.e. identifying in which sense a word (unit) is being used in a given context), Named Entity Recognition (NER) to tag identities e.g. places, names, organizations, etc for further analysis and relationship extraction (i.e. understanding how entities, such as places, persons, organisations, etc., relate to each other in a text). The unit comprehension parameter may be associated with a meaning of the unit to be displayed. For example, the meaning of the unit to be displayed may be determined using keyword analysis. In this way, a unit may be displayed for a longer display period of keyword analysis indicates that the unit is complex and therefore will take longer to be understood by the user e.g. medical or legal terminology. In some examples, the meaning of the unit may include determining whether a unit is: a loan word, a proper noun or a number expressed using digits or letters. A loan word (i.e. a word taken from another language) may take the user longer to understand than a word from the language of the rest of the document, so it is determined to display the unit corresponding to the loan word for a longer display period. A number expressed as a word using letters requires a longer display period than a number expressed using digits (e.g. ‘two hundred and forty five’ compared to ‘245’).

The unit comprehension parameter may be associated with a readability score of the document. The readability score may be a quantitative measurement of how easy a particular text is to read. The unit comprehension parameter may be associated with one or more symbols of the unit to be displayed. For example, the one or more symbols to be displayed may be at least one of: one or more logic symbols, one or more mathematical symbols, one or more diacritics and one or more accents. The unit comprehension parameter may be associated with one or more variables of the unit to be displayed compared to the other units of the document. For example, the display period for a unit to be displayed may be determined in dependence on a length of unit combinations (i.e. a group of short units may be displayed for a display period longer than the sum of the display periods of the individual units). In this way, a group of short units, such as: ‘To’, ‘be’, ‘or’, ‘not’, ‘to’, ‘be’; may be, in total, displayed in the predetermined position for a longer period of time than if the display period for each unit within this group had been determined independently from the other units before and after it. In some examples, the one or more variables of the unit to be displayed compared to the other units of the document may comprise a frequency of a unit within the document and/or the selected text portion. In some examples, the one or more variables of the unit to be displayed compared to the other units of the document may comprise a predictability of the unit to be displayed given the previously displayed units of the selected text portion. The unit comprehension parameter may be associated with statistics of the selected text portion. The statistics of the selected text portion may comprise a (an average) number of syllables per unit, an average number of letters per unit, a (an average) number of words per sentence, a (an average) number of units per paragraph and a (an average) number of sentences per paragraph.

It may be that the method comprises, in response to a first user input, interrupting the sequential display of the consecutive units of the selected text portion of the document in the predetermined position of the display screen. The method may further comprise sequentially displaying the consecutive units of the selected text portion, beginning from a first unit. The method may comprise determining the first unit in dependence on a factor associated with the user. Typically, the first unit is a unit previously displayed on the display screen at a time before the first user input. It may be that the instructions, when executed by the one or more processors, cause the controller to, in response to a first user input, interrupt the sequential display of the consecutive units of the selected text portion of the document in the predetermined position of the display screen. It may be that the instructions, when executed by the one or more processors, further cause the controller to sequentially display the consecutive units of the selected text portion, beginning from a first unit. It may be that the instructions, when executed by the one or more processors, further cause the controller to determine the first unit in dependence on a factor associated with the user. Typically, the first unit is a unit previously displayed on the display screen at a time before the first user input.

This in itself is believed to be novel and so, in accordance with a further aspect of the invention, there is provided a method of displaying a document to a user on a display screen in which the method comprises sequentially displaying, in a predetermined position of the display screen, consecutive units of a selected text portion of the document. The document may comprise text. The method may further comprise, in response to a first user input, interrupting the sequential display of the consecutive units of the selected text portion of the document in the predetermined position of the display screen. The method may further comprise determining a first unit in dependence on a factor associated with the user. The first unit may be a unit previously displayed on the display screen at a time before the first user input. It may be that the method further comprises sequentially displaying the consecutive units of the selected text portion, beginning from the first unit. In this aspect of the invention, the sequential display of consecutive units may be performed independently of an overview of a portion of the document.

The present invention further provides a controller for a display device to cause the display device to display a document to a user, the controller comprising: one or more processors; and a non-transitory computer readable memory storing instructions which, when executed by the one or more processors, causes the controller to sequentially display, in a predetermined position of the display screen, consecutive units of a selected text portion of the document. It may be that the instructions, when executed by the one or more processors, further cause the controller to, in response to a first user input, interrupt the sequential display of the consecutive units of the selected text portion of the document in the predetermined position of the display screen, determine a first unit in dependence on a factor associated with the user. The first unit may be a unit previously displayed on the display screen at a time before the first user input. It may be that the instructions, when executed by the one or more processors, further cause the controller to sequentially display the consecutive units of the selected text portion, beginning from the first unit.

Advantageously, this allows the user to return to a part of the selected portion of text that he/she may have missed. For example, the user may be distracted (e.g. by their environment) and miss a number of units displayed in the sequential display at the predetermined position. With a single user input, the user is able to return to a previously displayed unit and begin from this unit to start reading again. This allows for continued interaction with the display and is convenient for the user and improves reading efficiency. Significantly, the first unit is determined based on a factor associated with the user, rather than being pre-determined without consideration of the user. In this way, it may be that the determined first unit would be different for two users viewing the same text portion of the same document, interrupting the sequential display at the same unit of the selected text portion. Accordingly, a first unit can be determined which is suited to the particular user and their capabilities.

It may be that the first user input is a rewind input. That is, the first user input may be provided by the user when he/she wishes to return to a previously displayed unit. The user may provide the first user input when he/she has missed one or more of the displayed consecutive units.

Optionally, interrupting the sequential display of the consecutive units comprises stopping the current sequential display of consecutive units when the first user input is received. It may be that interrupting the sequential display comprises pausing the sequential display such that the unit displayed in the predetermined position at the time of the first user input is continuously displayed in the predetermined position. Alternatively, interrupting the sequential display may comprise not displaying a unit in the predetermined position.

Typically, the first unit is a previously displayed unit of the consecutive units from before the first user input is received. The first unit may be a unit before the first unit missed by the user. The first unit may have any position within the selected text portion. The sequential display of the consecutive units may resume beginning from the first unit.

Typically, the factor associated with the user comprises one or more variables associated with the user. For example, the one or more variables associated with the user may depend on at least one of: a user-selected parameter (e.g. a reading speed of the user) and a parameter related to the user but determined by the controller (e.g. a reading habit of the user or a variable associated with an environment of the user).

It may be that one or more variables associated with the user comprise a user's position in the text. That is, at the time of the first user input, it may be determined that a user's position in the text is near the start of a sentence (i.e. in the first half of the sentence according to number of words in the sentence). As a result, the first unit may correspond to the unit at the start of the sentence, thereby effectively restarting the scrolling display of the entire sentence. It may be determined that a user's position in the text is near the end of a sentence (i.e. in the second half of the sentence according to number of words in the sentence). As a result, the first unit may correspond to a fixed number of units before the unit displayed at the time of the first user input.

It may be that the method comprises determining, in a first determination step, that the user is viewing a position away from the predetermined position of the display screen; and in dependence thereon, interrupting the sequential display of the consecutive units of the selected text portion of the document in the predetermined position of the display screen. It may be that the instructions, when executed by the one or more processors, cause the controller to: determine, in a first determination step, that the user is viewing a position away from the predetermined position of the display screen; and in dependence thereon, interrupt the sequential display of the consecutive units of the selected text portion of the document in the predetermined position of the display screen.

This in itself is believed to be novel and so, in accordance with a further aspect of the invention there is provided a method of displaying a document to a user on a display screen, wherein the method comprises sequentially displaying, in a predetermined position of the display screen, consecutive units of a selected text portion of the document. The document may comprise text. The method may further comprise determining, in a first determination step, that the user is viewing a position away from the predetermined position of the display screen; and in dependence thereon, interrupting the sequential display of the consecutive units of the selected text portion of the document in the predetermined position of the display screen.

The present invention further provides a controller for a display device to cause the display device to display a document to a user, the controller comprising: one or more processors; and a non-transitory computer readable memory storing instructions which, when executed by the one or more processors, causes the controller to sequentially display, in a predetermined position of a display screen of the display device, consecutive units of a selected text portion of the document. The instructions, when executed by the one or more processors, may cause the controller to determine, in a first determination step, that the user is viewing a position away from the predetermined position of the display screen; and in dependence thereon, interrupt the sequential display of the consecutive units of the selected text portion of the document in the predetermined position of the display screen.

When the user is not looking at the predetermined position, they are not viewing the scrolling text and are therefore not reading the document. Advantageously, by automatically stopping the sequential display of the consecutive units (i.e. the scrolling) when the user is not looking at the predetermined position, the user does not miss part of the text. The user is not required to interact with the display screen to stop the sequential display which improves user convenience. For example, the user is not required to provide an input to stop the progression of the scrolling.

Typically, the first determination step comprises determining that the user is viewing the position away from the predetermined position by tracking an eye (i.e. pupil or iris) position of the user's eye. The position away from the predetermined position may be another position on the display screen that is not the predetermined position and/or a position away from the display screen. The first determination step may comprise detecting the eye position of the user's eye. The first determination step may further comprise comparing the detected eye position to an eye position corresponding to when the user is viewing the predetermined position. The first determination step may further comprise determining whether the user is viewing the predetermined position or a position away from the predetermined position in dependence on the comparison.

It may be that the display device comprises an eye tracking apparatus to perform eye tracking for the first determination step. The eye tracking apparatus may be external to the display device. The eye tracking apparatus may comprise distributed components in that a first group of components may be external to the display device and a second group of components may be accommodated within the display device. The controller may be configured to control the eye tracking apparatus of the display device. The eye tracking apparatus may communicate with the controller to transmit data to and/or receive data from the controller.

The eye tracking apparatus may comprise an imaging device. The imaging device may capture image data. The imaging device may transmit the image data to the controller. The controller may process the image data and may use image analysis techniques. The controller may determine a location of the user's eye. The controller may determine a gaze direction of the user. For example, the controller may identify the position of the pupil of the user's eye. The controller may compare the gaze direction with the predetermined position on the display screen. In this way, the controller may compare a position on the display screen that would be viewed by the user with the determined gaze direction to the predetermined position. If it is determined that the gaze direction corresponds to the predetermined position, the controller may determine that the user is viewing the predetermined position on the display screen. If it is determined that the gaze direction corresponds to a position away from the predetermined position, the controller may determine that the user is not viewing the predetermined position on the display screen.

It may be that interrupting the sequential display of the consecutive units is performed using a method similar to the method of interrupting the sequential display described above.

It may be that the method comprises determining, in a second determination step, that the user is viewing the predetermined position of the display screen; and in dependence thereon, resuming the sequential display of the consecutive units of the selected text portion of the document in the predetermined position of the display screen. It may be that the instructions, when executed by the one or more processors, cause the controller to: determine, in a second determination step, that the user is viewing the predetermined position of the display screen; and in dependence thereon, resuming the sequential display of the consecutive units of the selected text portion of the document in the predetermined position of the display screen.

Advantageously, once it is determined that the user is viewing the predetermined position on the screen, the scrolling resumes. The user is able to pick up from the last word in the text that has been read. This is an improvement over conventional reading in which the user often loses their place in the document or cannot remember where in the text they had read up to. Advantageously, the controller automatically keeps a record of where the user has read up to without requiring an input from the user to do so. This is particularly advantageous when the user has not looked at the predetermined position for a long period of time.

Typically, the second determination follows the first determination step. The second determination step may be initiated in dependence on the interruption of the sequential display of the consecutive units.

Optionally, the second determination step comprises determining that the user is viewing the predetermined position by tracking the eye (i.e. pupil or iris) position of the user's eye. It may be that determining that the user is viewing the predetermined position comprises determining that the user is viewing a region of the display screen comprising at least part of the predetermined position. The second determination step may be performed in a similar manner to the first determination step.

It may be that resuming the sequential display of the consecutive units comprises restarting the display of the consecutive units and sequentially progressing through displaying each unit of the selected text portion in order.

Typically, the sequential display of the consecutive units is resumed beginning from a second unit. The second unit may be a unit of the consecutive units displayed on the display screen at a time of the first determination step. That is, the second unit may correspond to the unit displayed in the predetermined position when the user looked away from the predetermined position. Alternatively, the second unit may be a previously displayed unit at a time before the first determination step. The second unit may be determined by returning to a unit displayed a specified number of units before the first determination step.

This in itself is believed to be novel and so, in accordance with a further aspect of the invention there is provided a method of displaying a document to a user on a display screen. The method comprises determining, in a start-up determination step, that the user is viewing a predetermined position of the display screen. The method may comprise, in dependence thereon, beginning sequentially displaying consecutive units of a selected text portion of the document in the predetermined position of the display screen.

The present invention further provides a controller for a display device to cause the display device to display a document to a user, the controller comprising: one or more processors; and a non-transitory computer readable memory storing instructions which, when executed by the one or more processors, causes the controller to determine, in a start-up determination step, that that the user is viewing a predetermined position of the display screen. It may be that the instructions, when executed by the one or more processors, further cause the controller to: begin sequential display of consecutive units of a selected text portion of the document in the predetermined position of the display screen.

This in itself is believed to be novel and so, in accordance with a further aspect of the invention there is provided a method of displaying a document to a user on a display screen. The document typically comprises text. The method comprises displaying an overview of a portion of the document on the display screen. The method comprises sequentially displaying, in a predetermined position of the display screen, consecutive units of a selected text portion of the overview of the portion of the document. The method comprises, simultaneously to displaying a displayed unit of the consecutive units of the selected text portion, displaying context comprising textual context of the displayed unit of the consecutive units.

The present invention further provides a controller for a display device to cause the display device to display a document to a user. The controller comprises one or more processors. The controller comprises a non-transitory computer readable memory storing instructions which, when executed by the one or more processors, causes the controller to: display an overview of a portion of the document on a display screen of the display device. Typically, the document comprises text. The instructions, when executed by the one or more processors, further cause the controller to sequentially display, in a predetermined position of the display screen, consecutive units of a selected text portion of the overview of the portion of the document. The instructions, when executed by the one or more processors, further causes the controller to, simultaneously to display of a displayed unit of the consecutive units of the selected text portion, display context comprising textual context of the displayed unit of the consecutive units.

A first general aspect of the present invention is a controller for a display device configured to cause the display device to display a document to a user. The controller includes one or more processors, and a non-transitory computer readable memory storing instructions which, when executed by the one or more processors, causes the controller to display an overview of a portion of the document on a display screen of the display device, the document comprising text, subsequently, sequentially display, in a predetermined position of the display screen, consecutive units of a selected text portion of the overview of the portion of the document, and simultaneously to display of a displayed unit of the consecutive units of the selected text portion, display context comprising textual context of the displayed unit of the consecutive units.

In embodiments, the instructions, when executed by the one or more processors, cause the controller to display each unit of the consecutive units of the selected text portion for a display period determined, for each unit, in dependence on one or more parameters, separate from a length of the displayed unit, the one or more parameters comprising, at least one of a document formatting parameter associated with at least one of: punctuation of the document, one or more paragraphs of the document, one or more headings of the document, text formatting of the document, a layout of the document and metadata of the document, and a unit comprehension parameter associated with at least one of: natural language processing techniques, a meaning of the unit to be displayed, a readability score of the document, one or more symbols of the unit to be displayed, one or more variables of the unit to be displayed compared to the other units of the document and statistics of the selected text.

In any of the above embodiments, the instructions, when executed by the one or more processors, can cause the controller to, in response to a first user input interrupt the sequential display of the consecutive units of the selected text portion of the document in the predetermined position of the display screen, determine a first unit in dependence on a factor associated with the user, wherein the first unit is a unit previously displayed on the display screen at a time before the first user input, and sequentially display the consecutive units of the selected text portion, beginning from the first unit.

In any of the above embodiments, the instructions, when executed by the one or more processors, can cause the controller to determine, in a first determination step, that the user is viewing a position away from the predetermined position of the display screen, and in dependence thereon, interrupt the sequential display of the consecutive units of the selected text portion of the document in the predetermined position of the display screen. In some of these embodiments, the instructions, when executed by the one or more processors, cause the controller to determine, in a second determination step, that the user is viewing the predetermined position of the display screen, and in dependence thereon, resuming the sequential display of the consecutive units of the selected text portion of the document in the predetermined position of the display screen. And in some of these embodiments, the sequential display of the consecutive units is resumed beginning from a second unit, wherein the second unit is a unit of the consecutive units displayed on the display screen at a time of the first determination step.

In any of the above embodiments, the context can comprise at least part of the selected text portion of the document.

In any of the above embodiments, the context can comprise, at least one of text intended for reading subsequent to the displayed unit, or text intended for reading prior to the displayed unit.

In any of the above embodiments, the context can comprise part of a clause or sentence of the selected text portion including the unit.

In any of the above embodiments, the context can include part of a sentence of the selected text portion which does not include the unit.

In any of the above embodiments, the context can be displayed on the display screen in a first position of the display screen adjacent to the predetermined position. In some of these embodiments, the first position is positioned to the left or right of the predetermined position of the display screen and/or the first position is positioned above or below the predetermined position.

In any of the above embodiments, the context can include pictorial context of the displayed unit.

In any of the above embodiments, the predetermined position of the display screen can be associated with a visual indication. In some of these embodiments, the displayed unit is displayed within the visual indication.

In any of the above embodiments, the instructions, when executed by the one or more processors, can cause the controller to receive a selection input from the user and initiate the sequential display, in the predetermined position of the display screen, of the consecutive units, subsequent to the selection input.

A second general aspect of the present invention is a controller for a display device that is configured to cause the display device to display a document to a user. The controller includes one or more processors, and a non-transitory computer readable memory storing instructions which, when executed by the one or more processors, causes the controller to sequentially display, in a predetermined position of a display screen of the display device, consecutive units of a selected text portion of the document, and display each unit of the consecutive units of the selected text portion for a display period determined, for each unit, in dependence on one or more parameters, separate from a length of the displayed unit, the one or more parameters comprising, at least one of a document formatting parameter associated with at least one of: punctuation of the document, one or more paragraphs of the document, one or more headings of the document, text formatting of the document, a layout of the document and metadata of the document, and a unit comprehension parameter associated with at least one of: natural language processing techniques, a meaning of the unit to be displayed, a readability score of the document, one or more symbols of the unit to be displayed, one or more variables of the unit to be displayed compared to the other units of the document and statistics of the selected text portion.

In embodiments, the instructions, when executed by the one or more processors, cause the controller to, simultaneously to displaying a displayed unit of the consecutive units of the selected text portion, display context comprising textual context of the displayed unit of the consecutive units.

A third general aspect of the present invention is a controller for a display device that is configured to cause the display device to display a document to a user. The controller includes one or more processors and a non-transitory computer readable memory storing instructions which, when executed by the one or more processors, causes the controller to sequentially display, in a predetermined position of the display screen, consecutive units of a selected text portion of the document, and in response to a first user input interrupt the sequential display of the consecutive units of the selected text portion of the document in the predetermined position of the display screen, determine a first unit in dependence on a factor associated with the user, wherein the first unit is a unit previously displayed on the display screen at a time before the first user input, and sequentially display the consecutive units of the selected text portion, beginning from the first unit.

In embodiments, the instructions, when executed by the one or more processors, cause the controller to, simultaneously to displaying a displayed unit of the consecutive units of the selected text portion, display context comprising textual context of the displayed unit of the consecutive units.

It will be understood that steps of method described hereinbefore with reference to any one particular method may be combined with any other herein-described method in substantially any combination, apart from those inherently incompatible.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

An example embodiment of the present invention will now be illustrated with reference to the following Figures in which:

FIGS. 1 to 4 are flow diagrams illustrating methods of displaying a document to a user on a display screen in accordance with aspects of the present inventions;

FIG. 5 is a schematic illustration of a controller in accordance with an aspect of the present invention;

FIGS. 6 to 8 illustrate a display screen according to an embodiment of the invention;

FIG. 9 illustrates a series of displays on a display screen according to an embodiment of the invention;

FIGS. 10 to 13 illustrate displays on a display screen according to an embodiment of the invention; and

FIG. 14 illustrates a series of displays on a display screen according to an embodiment of the invention.

### DETAILED DESCRIPTION

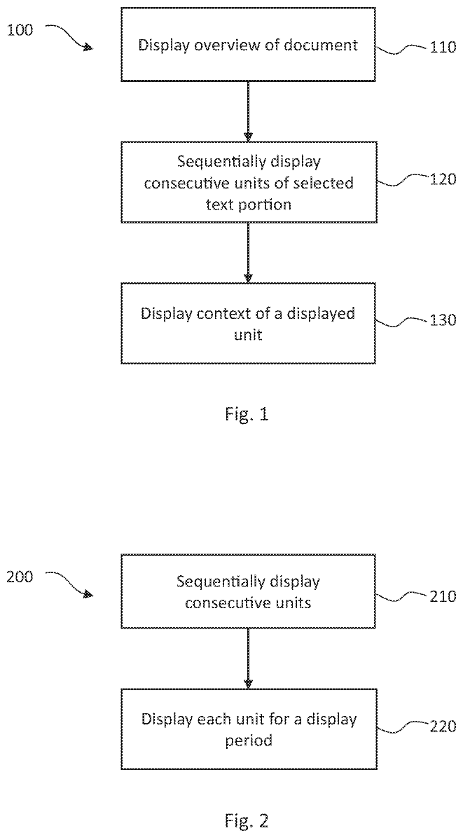

FIGS. 1 to 4 are flow diagrams illustrating methods of displaying a document to a user on a display screen. FIG. 1 shows a method 100 of displaying a document to a user on a display screen substantially as described hereinbefore. The method 100 is a method of displaying an overview of a document and subsequently displaying consecutive units (i.e. words) of portion of text from the document in sequence at the same time as displaying context of the displayed unit. The method comprises displaying 110 an overview of the document on the display screen. The overview is of a portion of the document. The method 100 further comprises, subsequently (to displaying the overview of the document), sequentially displaying 120, in a predetermined position of the display screen, consecutive units of a selected text portion. The selected text portion is a selected text portion of the overview of the portion of the document. The sequential display of the consecutive units represents scrolling across a line of text from the document. The method 100 further comprises, simultaneously to displaying a displayed unit of the consecutive units of the selected text portion, displaying 130 context comprising textual context of the displayed unit of the consecutive units. The context displayed simultaneously to display of the displayed unit of the consecutive units in the predetermined position is context in accordance with the previously described context.

FIG. 2 shows a method 200 of displaying a document to a user on a display screen substantially as described hereinbefore. The method 200 comprises displaying consecutive units in a predetermined position on a display screen in sequence, where the length of time each unit is displayed for is determined for each unit in dependence on one or more parameters. The method 200 comprises sequentially displaying 210, in a predetermined position of the display screen, consecutive units of a selected text portion of the document. The method 200 does not comprise sequentially displaying the consecutive units subsequent to displaying an overview of the document. The method further comprises displaying 220 each unit of the consecutive units of the selected text portion for a display period determined, for each unit, in dependence on one or more parameters, separate from a length of the displayed unit. The one or more parameters correspond to the one or more parameters described above.

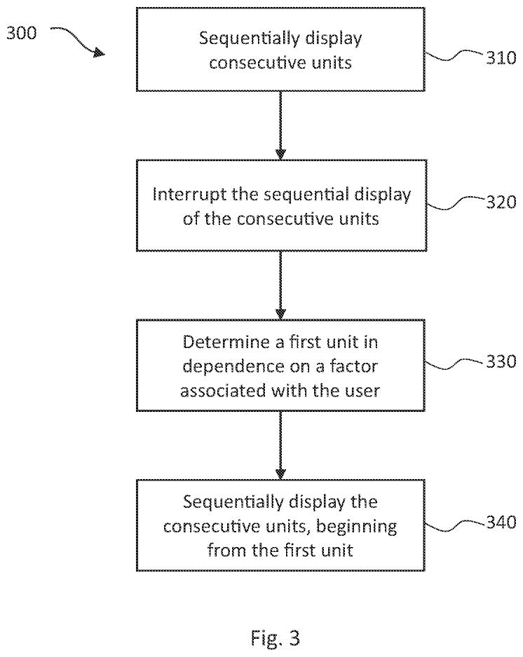

FIG. 3 shows a method 300 of displaying a document to a user on a display screen substantially as described hereinbefore. The method 300 comprises causing the display screen to return to a previously displayed unit of a selected text portion and continue the sequential display from the previously displayed unit. This allows the user to move backwards through the sequence of consecutive units (i.e. ‘rewind’). The method 300 comprises sequentially displaying 310, in a predetermined position of the display screen, consecutive units of a selected text portion of the document. The method 300 does not comprise sequentially displaying the consecutive units subsequent to displaying an overview of the document. The method 300 further comprises, in response to a first user input, interrupting 320 the sequential display of the consecutive units of the selected text portion of the document in the predetermined position of the display screen. The user input is an indication that the user intends to begin reading using the sequential display (i.e. scrolling).

The method 300 comprises determining 330 a first unit in dependence on a factor associated with the user. The factor associated with the user corresponds with the factor associated with the user described above. The first unit is a unit previously displayed on the display screen at a time before the first user input. The factor associated with the user may be a stored variable, a user-selected variable or a measured variable. The method 300 further comprises sequentially displaying 340 the consecutive units of the selected text portion, beginning from the first unit. In this way, scrolling of the text in the predetermined position occurs beginning from a previously displayed unit.

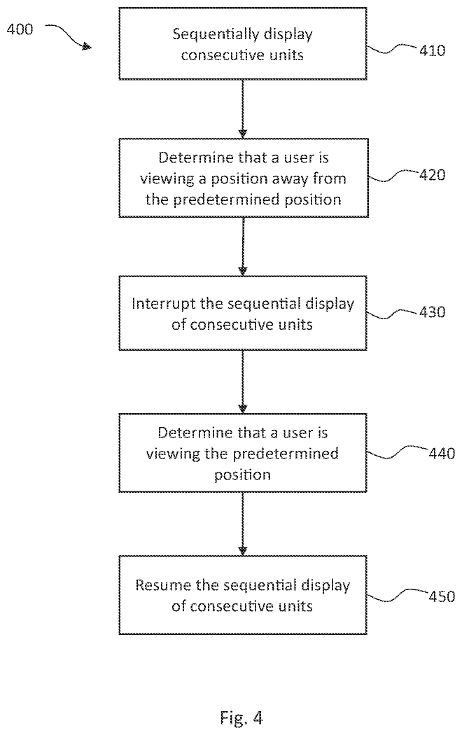

FIG. 4 shows a method 400 of displaying a document to a user on a display screen substantially as described hereinbefore. The method 400 comprises tracking the user's eye to determine whether the user is looking at a position that is not the predetermined position and stopping the progression of displaying consecutive units in sequence in dependence on determination that the user is not looking at the predetermined position. The method 400 comprises tracking a user's eye to determine whether the user is looking at the predetermined position and resuming the progression of displaying consecutive units in sequence in dependence on determination that the user is looking at the predetermined position. The method 400 comprises sequentially displaying 410, in a predetermined position of the display screen, consecutive units of a selected text portion of the document. The method 400 does not comprise sequentially displaying the consecutive units subsequent to displaying an overview of the document. The method 400 further comprises determining 420, in a first determination step, that the user is viewing a position away from the predetermined position of the display screen. The method 400 comprises in dependence on the first determination step, interrupting 430 the sequential display of the consecutive units of the selected text portion of the document in the predetermined position of the display screen. The method 400 comprises determining 440, in a second determination step, that the user is viewing the predetermined position of the display screen. The method 400 comprises, in dependence on the second determination step, resuming 450 the sequential display of the consecutive units of the selected text portion of the document in the predetermined position of the display screen. The resumption of the sequential display of the consecutive units is resumed from a second unit. The second unit is a previously displayed unit at a time before the first determination step or the time of the first determination step.

In other examples, the method 400 may comprise only method steps 410 to 430.

The methods illustrated in FIGS. 2 to 4, may further comprise a method step comprising simultaneously to displaying a displayed unit of the consecutive units of the selected text portion, displaying context comprising textual context of the displayed unit of the consecutive units.

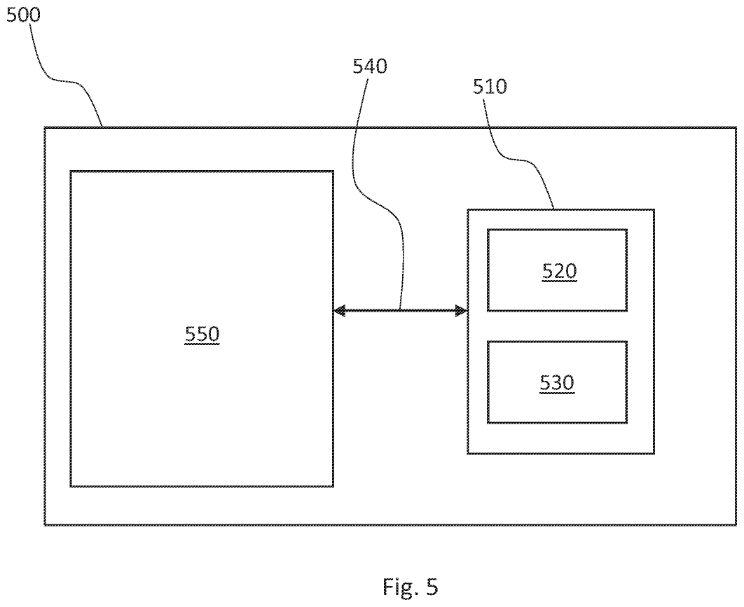

FIG. 5 is a schematic illustration of a controller in accordance with an aspect of the present invention. The controller 510 comprises one or more processors 520 and a non-transitory computer readable memory 530. The non-transitory computer readable memory 530 stores instructions which, when executed by the one or more processors 520, causes operation of the methods described herein. The controller 510 exchanges data and/or control signals 540 with the display screen 550. The display screen 550 is part of the display device 500. The controller 510 is part of the display device 500. The controller 510 causes the display device 500 to display a document to a user on the display screen 550. Alternatively, the controller 510 may be separate to the display device 500. The controller 510 may exchange data and/or control signals with an eye tracking apparatus (not illustrated).

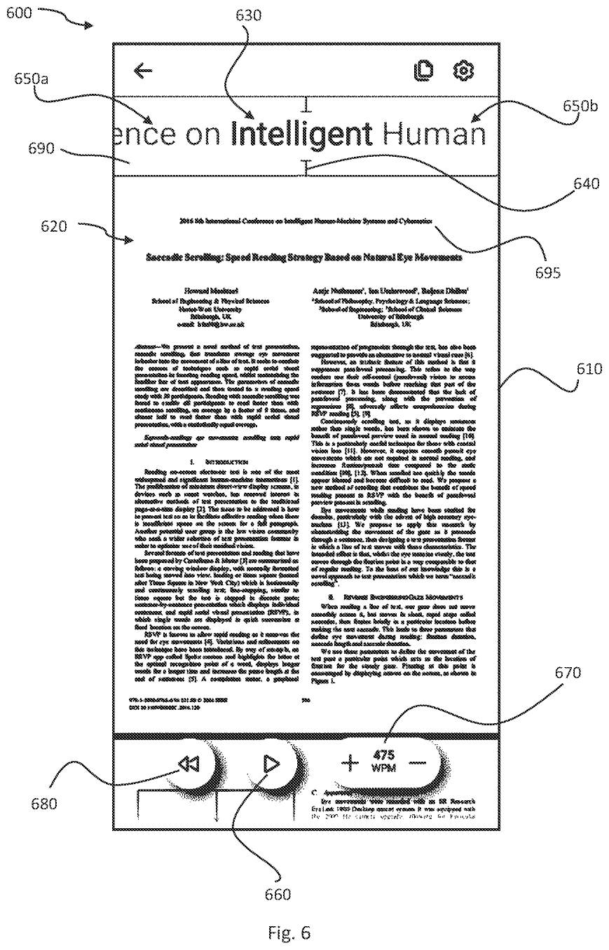

FIGS. 6 to 9 illustrate a display screen according to the invention. FIG. 6 shows a display 600 displaying an overview 620 of the document and a scroll window in which consecutive units of text of the document are sequentially displayed. The display 600 is shown on a display screen 610. The display screen 610 is a display screen in which the height of the screen is larger than the width of the screen. The display screen 610 is a display screen of a mobile phone. The display screen of a mobile phone is typically smaller than a display screen of a PC monitor, television or laptop screen. Other display screens may be smaller than a typical mobile phone display screen, for example a smart watch display screen. The display screen 610 displays the overview 620 of the document. In an upper portion of the display screen 610, the display screen 610 displays a number of consecutive units of a portion of text of the document. The unit displayed in the predetermined position 630 is the word: ‘Intelligent’. This word is taken from the selected portion of text 695. The predetermined position 630 is associated with the visual indication 640. The visual indication 640 comprises a pair of lines. The predetermined position 630 and the unit displayed within the predetermined position 630 is displayed between the visual indication 640. The predetermined position 640 is associated with a second visual indication, namely that the colour of the unit in the predetermined position 630 is different to other text displayed near to the predetermined position 630.

The text displayed near to the predetermined position is context 650a, 650b. On the left side of the predetermined position 630, the display screen 610 displays context 650a and on the right side of the predetermined position 630, the display screen 610 displays context 650b. The context 650a corresponds to units earlier in the sentence and consecutive to the word ‘Intelligent’ from the selected text portion 695. The context 650b corresponds to units later in the sentence and consecutive to the word ‘Intelligent’ from the selected text portion 695. The context 650a, 650b is displayed differently to the unit in the predetermined position 630. The unit displayed in the predetermined position 630 and the context 650a, 650b is displayed within the scroll window 690 located in the upper portion of the display screen 610. However, it will be appreciated that the position of the scroll window could be positioned elsewhere on the display screen.

The selected text portion 695 may be selected by a selection input from the user. The selected text portion may be selected by the controller by default according to the software code. For example, by default, the selected text portion may be the first sentence or first paragraph of the document. The initial unit of the selected text portion 695 may be loaded into the predetermined position 630 in dependence thereon. When the application first loads the document, the initial unit of the overview 620 of the document may be loaded into the predetermined position 630 by default.

FIG. 6 shows a number of ‘buttons’ 660, 670, 680 on the display screen 610. The ‘buttons’ correspond to regions of the display screen, which, when interacted with by the user, will cause the controller to perform a method described above. The buttons may alternatively be physical buttons on a display device in which the display screen 610 is accommodated.

The display screen 610 shows a ‘play button’ 660. The user may select the play button to initiate the sequential display of the consecutive units of the selected text portion 695 in the predetermined position 630. The display screen 610 shows a ‘speed selection button’. The user may interact with the speed selection button to set a speed for which the sequential display of the consecutive units progresses. The set speed may be shown in a region within the display of the speed selection button. The display screen 610 shows a ‘rewind button’ 680. The user may select the rewind button 680 to initiate the method shown in FIG. 3. It may be that display 610 comprises none, one or two of the buttons.

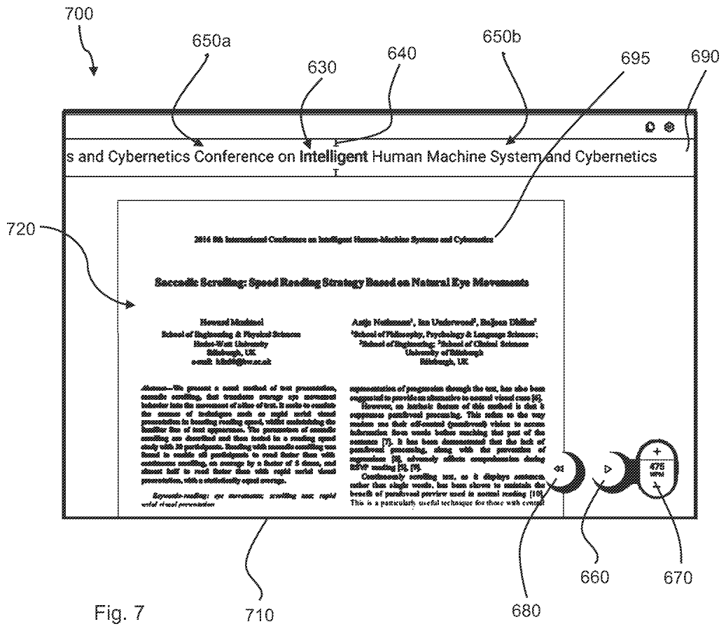

FIG. 7 shows a display 700 displaying an overview 720 of the document and a scroll window in which consecutive units of text of the document are sequentially displayed. The display 700 is shown on a display screen 710. The display screen 710 is a display screen in which the width of the screen is larger than the height of the screen. The display screen 610 is a display screen of a PC monitor. The display screen of the PC monitor is typically larger than a display screen of a mobile phone or smart watch. Other display screens may be larger than a typical PC monitor display screen, for example a television display screen. Similar features have been given corresponding reference numerals to the features of FIG. 6.

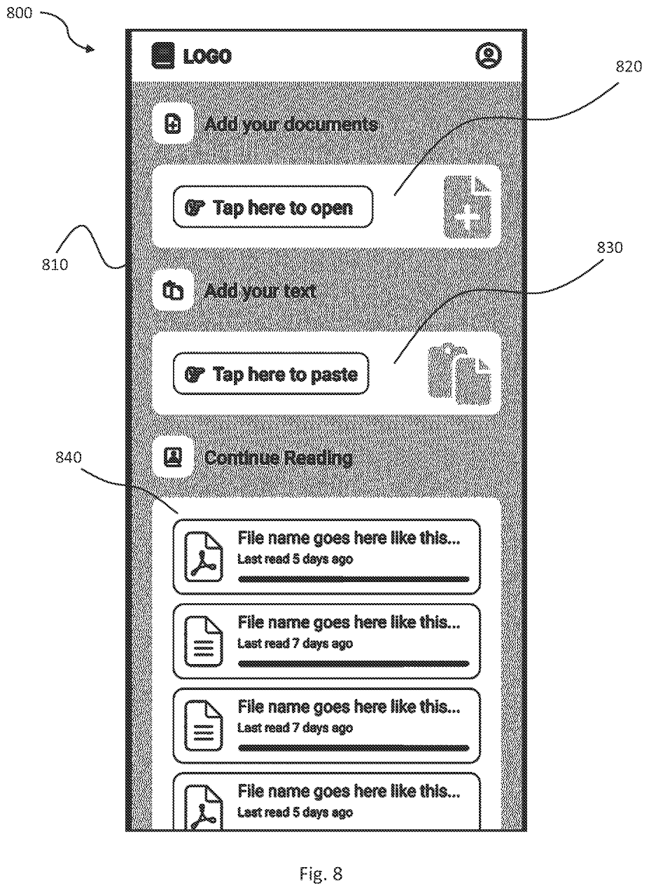

FIG. 8 illustrates a display 800 of display screen 810 in which the user is able to select a document to be displayed using the methods described above. In a first region 820 of the display screen 810, the user is able to upload a document to be viewed on the display 600 described above. In the second region 830 of the display screen 810, the user is able to insert text into a viewer to be viewed on the display 600 described above. In the third region 840, the user is able to view documents previously displayed on the display 600. It will be appreciated that a similar display may be provided for the display screen 710.

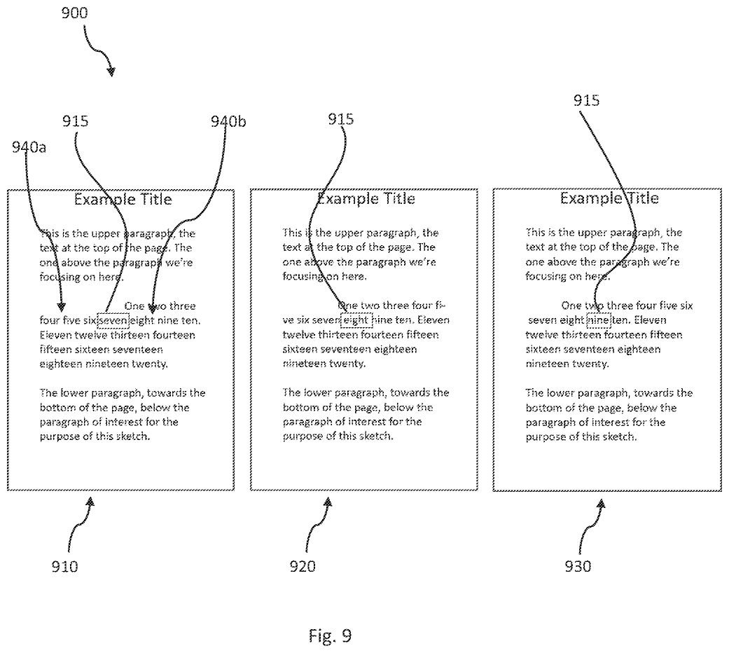

FIG. 9 illustrates a series of displays 900 showing the progression of the sequential display of the consecutive units on a display screen. In the series of displays 900, the consecutive units shown in the predetermined position 915 are “seven eight nine”. The predetermined position 915 is associated with a visual indication, namely a box outlining the unit in the predetermined position 915. In first display 910, the unit shown in the predetermined position 915 is “seven”, the context 940a is “four five six” and the context 940b is “eight nine ten”. In second display 920, the unit shown in the predetermined position 915 is “eight”, the context 940a is “ve six seven” and the context 940b is “nine ten. Eleven”. In this way, the unit displayed in the predetermined position 915 changes from “seven” to “eight” but the location of the predetermined position 915 on the display screen does not change. The context 940a 940b changes as the sequential display progresses through the consecutive units. In third display 930, the unit shown in the predetermined position 915 is “nine”, the context 940a is “seven eight” and the context 940b is “ten. Eleven”. In this way, the unit displayed in the predetermined position 915 changes from “eight” to “nine” but the location of the predetermined position 915 on the display screen does not change. Once again, the context 940a 940b changes as the sequential display progresses through the consecutive units. The context 940a, 940b may be considered as comprising text across multiple lines. For example, the context 940a may be considered as all of the text before the displayed unit in the same paragraph and the context 940b may be considered as all of the text after the displayed unit in the same paragraph.

When the displayed unit is a consecutive unit at the end of a line of text displayed on the display screen. The predetermined position 915 remains in the same location on the display screen and context adjusts around the predetermined position. The entirety of the text displayed on each display of the series of displays 900 may be considered an overview.

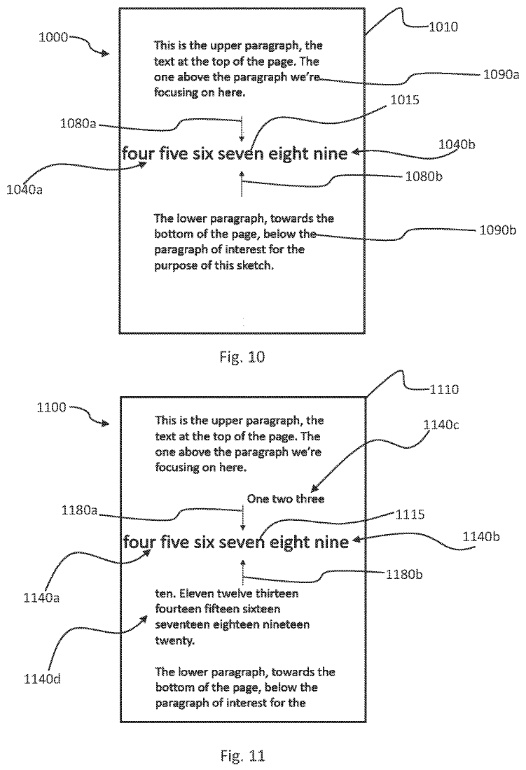

FIG. 10 illustrates a display 1000 on a display screen 1010. The display 1000 comprises a unit (the word “seven”) shown in the predetermined position 1015. The predetermined position is indicated by a visual indication of the arrows 1080a, 1080b pointing to the predetermined position 1015. Context 1040a, 1040b is displayed adjacent to the predetermined position 1015. The context 1040a, 1040b includes a portion of the sentence which fits on the same horizontal line as the unit in the predetermined position 1015. In this example, the context 1040a, 1040b does not include the entire sentence of the selected text portion and also does not include the entire paragraph of the selected text portion. The context 1040a, 1040b is shown using the same colour text as the unit displayed in the predetermined position 1015. However, it will be appreciated that the context 1040a, 1040b could be shown using a different colour text to the unit displayed in the predetermined position 1015. The text 1090a, 1090b is additional text which is from a different paragraph to the selected text portion, However, in some examples, the additional text 1090a, 1090b may be considered as part of the context.

FIG. 11 illustrates a display 1100 on a display screen 1110. The display 1100 comprises a unit (the word “seven”) shown in the predetermined position 1115. The predetermined position 1115 is indicated by arrows 1180a, 1180b. Context 1140a, 1140b is displayed adjacent to the predetermined position 1115. The context 1140a, 1140b includes a portion of the sentence which fits on the same horizontal line as the unit in the predetermined position 1015. In this example, the context 1140c, 1140d, includes the entire sentence of the selected text portion and the entire paragraph of the selected text portion. The context 1140c includes the units of the selected text portion which are included in the selected text portion before the first unit displayed on the same line as the predetermined position 1115 (i.e. the first unit of the context 1140a). The context 1140d includes the units of the selected text portion which are included in the selected text portion after the last unit displayed on the same line as the predetermined position 1115 (i.e. the last unit of the context 1140b). The context 1140a, 1140b is shown using the same colour text as the unit displayed in the predetermined position 1115. The context 1140c, 1140d is shown using a different colour text to the unit displayed in the predetermined position 1115. Although not labelled, the remaining text displayed on the display 1100 corresponds to the additional text 1090a, 1090b from FIG. 10.

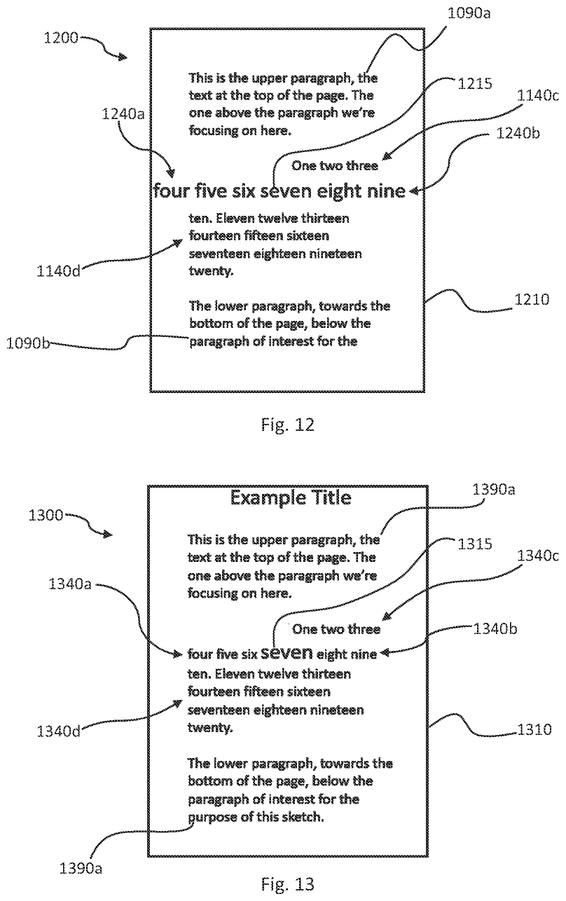

FIG. 12 illustrates a display 1200 on a display screen 1210. The display 1200 is substantially the same as display 1100 from FIG. 11, differing in that the display 1200 does not show the arrows 1180a, 1180b from the display 1100 of FIG. 11. In this example, the unit in the predetermined position 1215 is not distinguished in font from the context 1240a, 1240b.

FIG. 13 illustrates a display 1300 on a display screen 1310. The display 1300 is substantially the same as display 1200 from FIG. 12, differing in that the display 1300 shows context 1340a, 1340b in the same font as the context 1340c, 1340d and the additional text 1390a, 1390b.

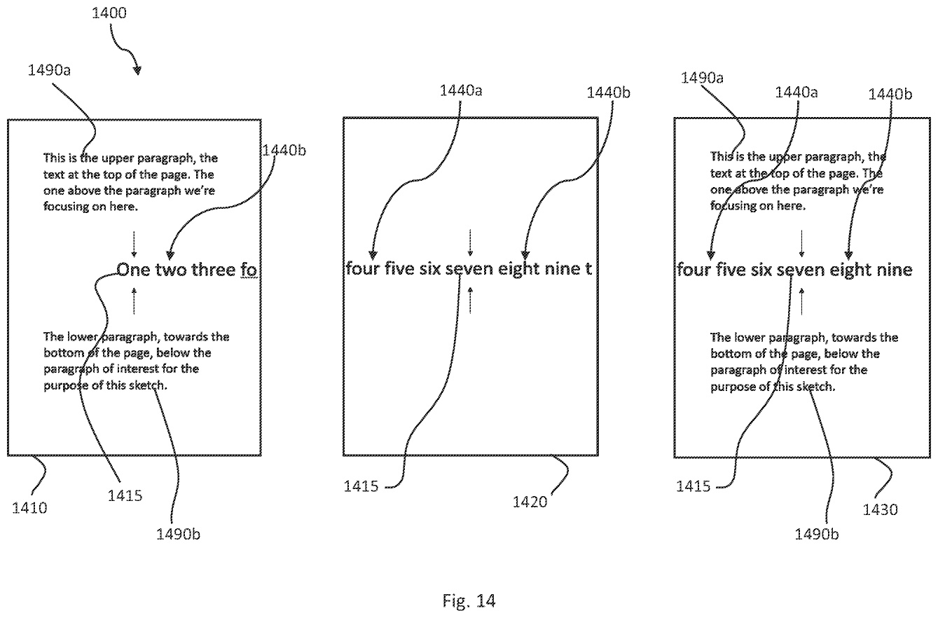

FIG. 14 illustrates a series of displays 1400 showing the different modes of display on a display screen. In each of the displays 1400, the predetermined position 1415 is associated with a visual indication, namely arrows pointing to the unit in the predetermined position 1415. The first display 1410 may correspond to an initial display. In the first display 1410, the unit shown in the predetermined position 1415 is “One”. This unit corresponds to the first word in a sentence in the selected text portion. The context 1440b is “two three fo” and is shown after the predetermined position because these words follow the unit displayed in the predetermined position 1415 in the selected text portion. In the first display 1410, there is no context shown on the same horizontal line as the predetermined position 1415 because the unit in the predetermined position 1415 is the first unit in the selected text portion. In the first display 1410, additional text 1490a is shown above the predetermined position 1415 and additional text 1490b is shown in below the predetermined position 1415. It will be understood that the additional text 1490a corresponds to the paragraph immediately preceding the selected text portion and that the additional text 1490b corresponds to the paragraph immediately proceeding the selected text portion.

The second display 1420 may correspond to a scrolling display in which the sequential units are sequentially displayed. In the second display 1420, the unit shown in the predetermined position 1415 is “seven”. As will be appreciated, this unit is be shown as the seventh display in a sequence. That is, the previous displays display “One”, “two”, “three”, “four”, “five” and “six” each in the predetermined position 1415. Since this unit is not the first unit in the selected text portion, the context 1440a displays “four five six” because these words are included before “seven” in the selected text portion. The context 1440b is “eight nine t” as this text follows “seven” in the selected text portion. The additional text 1490a, 1490b is not shown in the scrolling display. This improves the user's focus on the predetermined position. In some examples, the scrolling display is initiated in dependence on a user input.

The third display 1430 may correspond to a paused display which is substantially similar to the initial display. In the third display 1430, the unit shown in the predetermined position 1415 is “seven”. The context 1440a, 1440b is the same as shown in the second display 1420. However, in the paused display, the display 1430 also shows the additional text 1490a above the predetermined position 1415 and the additional text 1490b below the predetermined position 1415. In some examples, the paused display is initiated in dependence on a user input.

The series of displays 1400 shows the different modes of display available to the user. In the initial and paused display, more information is available to the user to improve understanding of the document. In the scrolling display, this information is removed to improve the user's focus on the text to be read.

In general, the invention relates to a method of displaying a document to a user on a display screen and a controller for a display device to cause the display device to display a document to a user. The document comprises text. An overview of a portion of the document may be displayed on the display screen. The display screen sequentially displays, in a predetermined position of the display screen, consecutive units of a selected text portion of the document. The sequential display of the consecutive units may be subsequent to displaying the overview of the document. The display screen may, simultaneously to display of a displayed unit of the consecutive units of the selected text portion, display context comprising textual context of the displayed unit of the consecutive units.

Throughout the description and claims of this specification, the words “comprise” and “contain” and variations of them mean “including but not limited to”, and they are not intended to and do not exclude other components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, or groups described in conjunction with a particular aspect, embodiment, or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A controller for a display device configured to cause the display device to display a document to a user, the controller comprising:
one or more processors; and
a non-transitory computer readable memory storing instructions which, when executed by the one or more processors, causes the controller to:
display an overview of a portion of the document on a display screen of the display device, the document comprising text;
subsequently, sequentially display, in a predetermined position of the display screen, consecutive units of a selected text portion of the overview of the portion of the document; and
simultaneously to display of a displayed unit of the consecutive units of the selected text portion, display context comprising textual context of the displayed unit of the consecutive units.

2. The controller of claim 1, wherein the instructions, when executed by the one or more processors, cause the controller to:
display each unit of the consecutive units of the selected text portion for a display period determined, for each unit, in dependence on one or more parameters, separate from a length of the displayed unit, the one or more parameters comprising, at least one of:
a document formatting parameter associated with at least one of: punctuation of the document, one or more paragraphs of the document, one or more headings of the document, text formatting of the document, a layout of the document and metadata of the document; and
a unit comprehension parameter associated with at least one of: natural language processing techniques, a meaning of the unit to be displayed, a readability score of the document, one or more symbols of the unit to be displayed, one or more variables of the unit to be displayed compared to the other units of the document and statistics of the selected text.

3. The controller of claim 1, wherein the instructions, when executed by the one or more processors, cause the controller to, in response to a first user input:
interrupt the sequential display of the consecutive units of the selected text portion of the document in the predetermined position of the display screen,
determine a first unit in dependence on a factor associated with the user, wherein the first unit is a unit previously displayed on the display screen at a time before the first user input, and
sequentially display the consecutive units of the selected text portion, beginning from the first unit.

4. The controller of claim 1, wherein the instructions, when executed by the one or more processors, cause the controller to:
determine, in a first determination step, that the user is viewing a position away from the predetermined position of the display screen; and
in dependence thereon, interrupt the sequential display of the consecutive units of the selected text portion of the document in the predetermined position of the display screen.

5. The controller of claim 4, wherein the instructions, when executed by the one or more processors, cause the controller to:
determine, in a second determination step, that the user is viewing the predetermined position of the display screen; and
in dependence thereon, resuming the sequential display of the consecutive units of the selected text portion of the document in the predetermined position of the display screen.

6. The controller of claim 5, wherein the sequential display of the consecutive units is resumed beginning from a second unit, wherein the second unit is a unit of the consecutive units displayed on the display screen at a time of the first determination step.

7. The controller of claim 1, wherein the context comprises at least part of the selected text portion of the document.

8. The controller of claim 1, wherein the context comprises, at least one of:
text intended for reading subsequent to the displayed unit, or
text intended for reading prior to the displayed unit.

9. The controller of claim 1, wherein the context comprises part of a clause or sentence of the selected text portion including the unit.

10. The controller of claim 1, wherein the context comprises part of a sentence of the selected text portion which does not include the unit.

11. The controller of claim 1, wherein the context is displayed on the display screen in a first position of the display screen adjacent to the predetermined position.

12. The controller of claim 11, wherein the first position is positioned to the left or right of the predetermined position of the display screen and/or the first position is positioned above or below the predetermined position.

13. The controller of claim 1, wherein the context comprises pictorial context of the displayed unit.

14. The controller of claim 1, wherein the predetermined position of the display screen is associated with a visual indication.

15. The controller of claim 14, wherein the displayed unit is displayed within the visual indication.

16. The controller of claim 1, wherein the instructions, when executed by the one or more processors, cause the controller to:
receive a selection input from the user; and
initiate the sequential display, in the predetermined position of the display screen, of the consecutive units, subsequent to the selection input.

17. A controller for a display device to cause the display device to display a document to a user, the controller comprising:
one or more processors; and
a non-transitory computer readable memory storing instructions which, when executed by the one or more processors, causes the controller to:
sequentially display, in a predetermined position of a display screen of the display device, consecutive units of a selected text portion of the document; and
display each unit of the consecutive units of the selected text portion for a display period determined, for each unit, in dependence on one or more parameters, separate from a length of the displayed unit, the one or more parameters comprising, at least one of:
a document formatting parameter associated with at least one of: punctuation of the document, one or more paragraphs of the document, one or more headings of the document, text formatting of the document, a layout of the document and metadata of the document, and
a unit comprehension parameter associated with at least one of: natural language processing techniques, a meaning of the unit to be displayed, a readability score of the document, one or more symbols of the unit to be displayed, one or more variables of the unit to be displayed compared to the other units of the document and statistics of the selected text portion.

18. The controller of claim 17, wherein the instructions, when executed by the one or more processors, cause the controller to, simultaneously to displaying a displayed unit of the consecutive units of the selected text portion, display context comprising textual context of the displayed unit of the consecutive units.

19. A controller for a display device to cause the display device to display a document to a user, the controller comprising:
one or more processors; and
a non-transitory computer readable memory storing instructions which, when executed by the one or more processors, causes the controller to:
sequentially display, in a predetermined position of the display screen, consecutive units of a selected text portion of the document; and
in response to a first user input:
interrupt the sequential display of the consecutive units of the selected text portion of the document in the predetermined position of the display screen,
determine a first unit in dependence on a factor associated with the user, wherein the first unit is a unit previously displayed on the display screen at a time before the first user input, and
sequentially display the consecutive units of the selected text portion, beginning from the first unit.

20. The controller of claim 19, wherein the instructions, when executed by the one or more processors, cause the controller to, simultaneously to displaying a displayed unit of the consecutive units of the selected text portion, display context comprising textual context of the displayed unit of the consecutive units.
